(19) United States
(12) Patent Application Publication
(10) Pub. No.: US 2005/0228088 A1
(43) Pub. Date: Oct. 13, 2005

(54) Precipitation of additives in over-saturated triblock copolymer elastomers

(76) Inventor: Aldo A. Laghi, Clearwater, FL (US)

Correspondence Address: Carlton Fields, P.A., P.O. Box 3239, Tampa, FL, 33601-3239, US

(21) Appl. No.: 10/817,612

(22) Filed: Apr. 2, 2004

(51) Int. Cl. C08K 5/49

(52) U.S. Cl. 524/115

(57) ABSTRACT

A method of making a durable, low friction elastomer that may remain in prolonged contact with human skin or other tissue without causing discomfort. The method includes the steps of mixing together a plasticizing oil, a polymer, and an additive. The mixture is melted so that the additives become soluble in the molten mixture. The molten mixture is molded into the shape of a useful item. When the molded item cools, the mixture becomes an elastomer and the additives begin to precipitate from the elastomer, migrating under a diffusion process to the surface of the molded item where they form a beneficial, friction reducing dry powder. The method also produces micro-craters on the surface of the elastomer that further reduce friction when liquid fluid is collected within the micro-craters.

### BACKGROUND OF THE INVENTION

1. Field of the Invention

This invention relates to an elastomer composition having qualities that make it suitable for prolonged contact with human skin.

2. Description of the Prior Art

U.S. Pat. No. 4,678,664 discloses a gel composition that includes water, mineral oil and two polyoxyethylene-polyoxybutylene block copolymers designated copolymer A and copolymer B. The block copolymers are cogeneric mixtures of conjugated polyoxybutylene-polyoxyethylene compounds containing in their structure oxybutylene groups, oxyethylene groups and an organic radical derived from a water-soluble organic compound containing a plurality of reactive hydrogen atoms and 2 to 12 carbon atoms.

U.S. Pat. No. 4,369,284 discloses a gelatinous composition that contains an intimate melt blend admixture of poly(styrene-ethylene-butylene-styrene) triblock copolymer having a styrene end block to ethylene and butylene center block ratio within the range of 31:69 to 40:60, and high levels of a plasticizing oil. The gelatinous composition is transparent and has a combination of properties including high elongation and tensile strength and shape retention after deformation under velocity impact and stress conditions. The gelatinous products of this invention are soft, flexible, and have elastic memory, characterized by a gel rigidity of from about 20 gram to about 700 gram Bloom.

Products made from these gelatinous compositions tend to rupture and crumble when under shearing stress conditions. Moreover, these prior methods and products do not have certain surface characteristics of elastomers which are beneficial in a variety of applications. More particularly, if used in applications where the composition is in prolonged contact with human skin, the friction produced by such products, coupled with a lack of sufficient lubrication, can produce patient discomfort.

What is needed is an improved method of making an elastomer composition where the surface characteristics of the elastomer are beneficial in skin contact applications. Specifically, the needed elastomer composition would provide enhanced patient comfort and satisfaction when used in applications that include prolonged skin contact.

### SUMMARY OF INVENTION

The long-standing but heretofore unfulfilled need for a durable elastomer having enhanced utility in applications involving sustained contact with human skin is now met by a new, useful, and non-obvious invention.

The novel elastomer composition is formed by mixing together a plasticizing oil, preselected additives, and a polymer to form a mixture. The mixture is heated until it becomes molten and the molten mixture is charged into a mold for producing useful items.

The additives are in a stable solution when the mixture is in its molten state. An elastomer is formed when the molten mixture cools and solidifies. As the mixture cools down the solubility of the additives decreases and the mixture becomes a supersaturated solution. When solidification is complete, the additives begin to precipitate from the elastomer. The additives migrate, through the process of diffusion, to the surface of the elastomer where they form a powdery interface with a user's skin. This greatly improves the comfort of the user and enables the elastomer to remain in contact with the user's skin for prolonged periods of time.

The plasticizing oil may be heated prior to mixing the additive and polymer therewith, but such heating is not strictly necessary. An extruder, a molding machine, or other similar heated vessel is used to accomplish the above-mentioned melting of the mixture so that the additives become melted and soluble in the molten mixture.

Precipitation of the additives begins after solidification of the elastomer. More particularly, the additives remain dissolved in the molten mixture until the mixture solidifies and becomes an elastomer. Precipitation of the additives from the elastomer begins after the elastomer has cooled and solidified. The additives that precipitate and reach the surface of the elastomer provide a dry layer of microscopic powder on the elastomer surface.

The novel process also produces micro-craters on the surface of the elastomer. Both the powder and the micro-craters reduce friction between the user's skin or other human tissue and the elastomer. Even if the surface is wet, the micro-craters collect small pools of liquid that provide lubricity.

### BRIEF DESCRIPTION OF THE DRAWINGS

For a fuller understanding of the invention, reference should be made to the following detailed description, taken in connection with the accompanying drawings and photographs, in which:

FIG. 1 is a diagrammatic view of an embodiment of the invention.

FIG. 2 is a side-elevated, partially sectional diagrammatic view of the elastomer surface according to an embodiment of the invention.

FIG. 3 is a side-elevated, partially sectional diagrammatic view of the elastomer surface in contact with an epidermal surface according to an embodiment of the invention.

FIG. 4 is a side-elevated, partially sectional diagrammatic view of the elastomer surface illustrating the migration of compounds from the surface of the elastomer to overlaying tissue according to an embodiment of the invention.

FIG. 5 is a photograph of the modified surface as molded with a 50× magnification.

FIG. 6 is a photograph of the modified surface during the cooling period with a 50× magnification.

FIG. 7 is a photograph of the modified surface after an appropriate cooling period with a 50× magnification. FIG. 8 is a photopgraph of the modified surface after an inappropriate cooling period with a 50× magnification.

### DETAILED DESCRIPTION OF THE PREFERRED EMBODIMENT

As used herein, the term “elastomers” refers to materials having attributes similar to gels. One important attribute of a gel is that its physical state is normally neither a liquid nor a solid. Gels do not seek to fill a container and do not necessarily have a level surface. Gels keep their own shape when they are subjected to gravity. Gels self-heal when cut, have substantially no resistance to traction, and have substantially no elongation.

Examples of true gels are the gels used in food gelatins, wound care, and lubricants. In the present disclosure, triblock polymers, when mixed with plasticizing oils, produce elastomers that exhibit good mechanical properties, including elongation, tear and tensile strength characteristics.

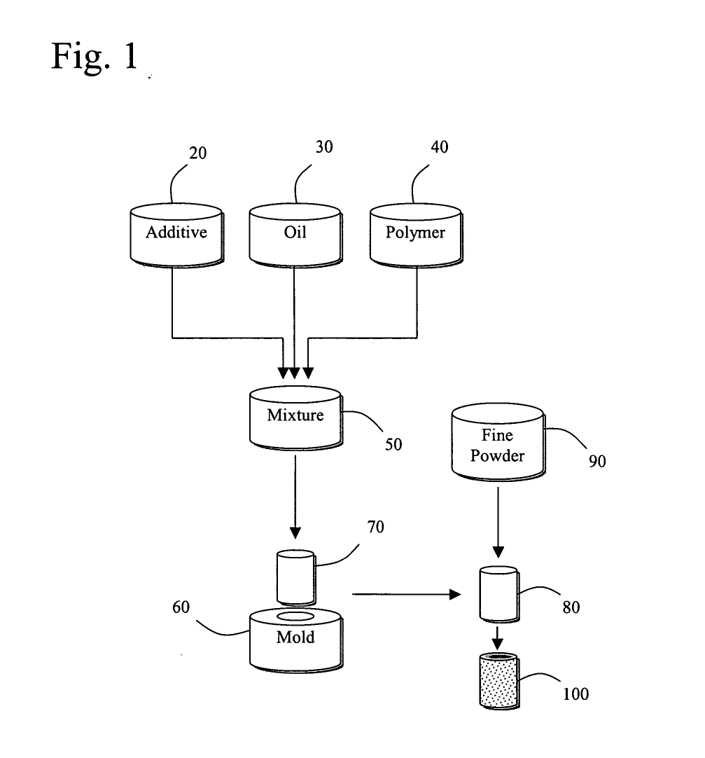

Turning to FIG. 1, the novel process of making an elastomer includes the steps of mixing additive 20, plasticizing oil 30, and polymer 40 to form mixture 50. Plasticizing oil 30 may be heated prior to the addition of additive 20 and polymer 40 thereto, but such heating is not critical to the invention. Mixture 50 is melted in an extruder, a molding machine or other suitable heated vessel so that the additives become soluble in molten mixture 50 and remain in stable solution in the molten mixture. Molten mixture 50 is molded 60 into the form of a useful item to at an appropriate temperature. When allowed to cool, the mixture solidifies and forms elastomer 80. The additives begin to diffuse to the surface of the elastomer upon completion of the solidification process. Precipitation may be initiated by seeding the surface of elastomer 80 with fine powder 90 such as talcum powder. Elastomer 80 is cooled to solidified elastomer 100 whereby additive 20 precipitates to the surface of solidified elastomer 100 in the form of a dry powder.

If the plasticizing oil is heated, the appropriate temperature range is about 130 to 165° F. Plasticizing oils such as paraffinic oils, naphtenic petroleum oils, mineral oils, and synthetic liquid oilgomers of polybutene, polypropylene, polyterpene, etc. may be used. Optionally, a seeding of the oil may also be effected, with an insoluble fine powder such as talc. Preferably, 300 to 1000 parts by weight of the plasticizing oil may be used.

The additive is mixed in the plasticizing oil, optionally with seed, for approximately 10 minutes at 130 to 165° F. The additive may also be added to the plasticizing oil with or after the addition of the polymer. Table I discloses suitable additives.

TABLE I

| | Chemical Name |
|---|---|
| 1 | Tetrakis (2,4-di-tert-butylphenyl) [1,1-biphenyl]-4,4′-diylbisphosphonite |
| 2 | Tris (2,4-ditert-butylphenyl) phosphate |
| 3 | Butanedioic acid, dimethylester, polymer with 4-hydroxy-2,2,6,6-tetramethyl-1-piperidine ethanol |
| 4 | 2,6-di-tert-butyl-4-(4,6-bis(octylthio)-1,3,5-triazin-2-ylamino) phenol |
| 5 | 3,3′,3′,5,5′,5′-hexa-tert-butyl-a,a′,a′-(mesitylene-2,4,6-triyl) tri-p-cresol |
| 6 | Pentaerythritol Tetrakis (3-(3,5-di-tert-butyl-4-hydroxphenyl)propionate) |
| 7 | Phenol, 2-(5-chloro-2H-benzotriazole-2-yl)-6-(1,1-dimethylethyl)-4-methyl |
| 8 | Thiodiethylene bis[3-(3,5-di-tert-butyl-4-hydroxyphenyl)propionate] |
| 9 | Calcium phosphonate |
| 10 | Dioctadecyl 3,3′-thiodipropionate |
| 11 | Didodecyl 3,3′-thiodipropionate |
| 12 | 2-(1,1-dimethylethyl)-6-[ [3-(1,1-dimethylethyl)-2-hydroxy-5-methylphenyl] methyl-4- |
| | methylphenyl acrylate |
| 13 | N,N′-hexane-1,6-diylbis(3-(3,5-di-tert-butyl-4-hydroxyphenylpropionamide)) |

The tris (2,4-ditert-butylphenyl) phosphate as listed in Table I is a white crystalline powder, commonly used as a phosphate processing stabilizer for polycarbonate and polyolefins. It is typically used in combination with phenolic antioxidants and acts for synergistical color stability and polymer viscosity. The butanedionic acid as listed in Table I, also known as succinic acid, is a dicarboxylic acid with four carbon atoms, occurs naturally in plant and animal tissues and plays a significant role in intermediary metabolism (Krebs cycle). It is a colorless crystalline solid with a melting point of 185-187° C., soluble in water, slightly dissolved in ethanol, ether, acetone and glycerine, but not dissolved in benzene, carbon sulfide, carbon tetrachloride and oil ether. The common method of synthesis of succinic acid is the catalytic hydrogenation of maleic acid or its anhydride. Succinic acid has uses in certain drug compounds, in agricultural and food production, and in perfume esters.

Preferably, 0.5 to 10 parts of one or more additives is mixed with the plasticizing oil or with the plasticizing oil and polymer mixture. The additives are solid at room temperature (25° C.) and soluble in the molten mixture. The additives have higher solubility in the triblock copolymer elastomers at higher temperatures than at room temperatures. The addition of such additives is in a predetermined proportion that exceeds the solubility of the additives in the elastomer at room temperature. The addition of such additives to the mixture of polymers and plasticizing oil is made either prior to the melting of the mixture in a heated vessel or when the mixture is in its molten state.

A polymer or mixture of polymers is added to the plasticizing oil or to the mixture of plasticizing oil and additives for 30 minutes at 140° F. to 165° F. starting temperature. The polymers may be of the type poly (styrene ethylene ethylene propylene styrene) (SEEPS), poly (styrene ethylene butylenes styrene) (SEBS), or poly (styrene ethylene propylene styrene) (SEPS). These polymers are sold under the trademarks Septon® and Kapton®. Preferably, 100 parts by weight of one or a mixture of two or more of a hydrogenated styrene/isoprene/butadiene block copolymer are used.

The mixture containing the plasticizing oil, the additive and the polymer is melted in an extruder, a reciprocating screw molding machine, or a heated vessel at about 415° F. As mentioned earlier, the additive may be added to the mixture of polymers and plasticizing oils either prior to the melting of the mixture or in the melt phase.

After melting, the mixture is maintained at an elevated temperature, with or without mixing, for an amount of time necessary to ensure adequate dissolution and dispersion of the additives in the mixture. After the expiration of such amount of time, the mixture is allowed to cool or is actively cooled. In either event, the mixture undergoes a phase change from liquid to solid. The additives remain dissolved in the molten mixture, but upon solidification of the mixture, the mixture becomes an elastomer and precipitation of the additives from the elastomer begins.

More particularly, where the mixture is first melted and then cooled, at a controlled temperature profile, precipitation of the additives occurs within the elastomer as the solubility parameters of the additive in the elastomer are exceeded. The solubility of the additives decreases as the temperature of the elastomer falls. Precipitation may be initiated by seeding the surface of the elastomer with a fine powder such as talcum powder. Precipitation may also be initiated by mechanical solicitation of the elastomer, such as stretching or other deformation of the elastomer.

The size of the particles of the precipitated phase is a function of the time temperature profile maintained during the cooling period and of the mechanical stress to which the elastomer is subjected. More particularly, the particles increase in size as the cooling rate is decreased and as the amount of mechanical deformation is decreased. A faster cooling rate and greater mechanical deformation produces smaller particle sizes.

The diffusion rate of precipitate to the surface of the liner also increases as the stress to strain ratio decreases, i.e., the diffusion rate increases as the modulus of the elastomer, or elastic limit stress, decreases.

Molding, casting or extruding of the molten mixture is preferably conducted at a mold temperature of 95-130° F. for 5-10 minutes. The molded elastomer is removed from the mold after the expiration of such period of time. Although stretching is not required, stretching of the elastomer by about 50% will improve the diffusion rate. Other mechanical deformation of the elastomer may be substituted for or added to the stretching.

A precipitation seed such as talcum powder may also be applied to the surface of the molded part.

The step of aging at a controlled temperature profile may also be performed. The aging may be accomplished at a temperature of 20-32° F. for one (1) hour.

The precipitated phase diffuses to the surface of the elastomer and collects as a powder on its surface. After removal of the surface powder, by wiping, washing, or the like, additional powder migrates to the surface. The process is repeated until the saturation level at room temperature of the precipitate phase in the elastomer is reached. The process of diffusion to the surface then stops.

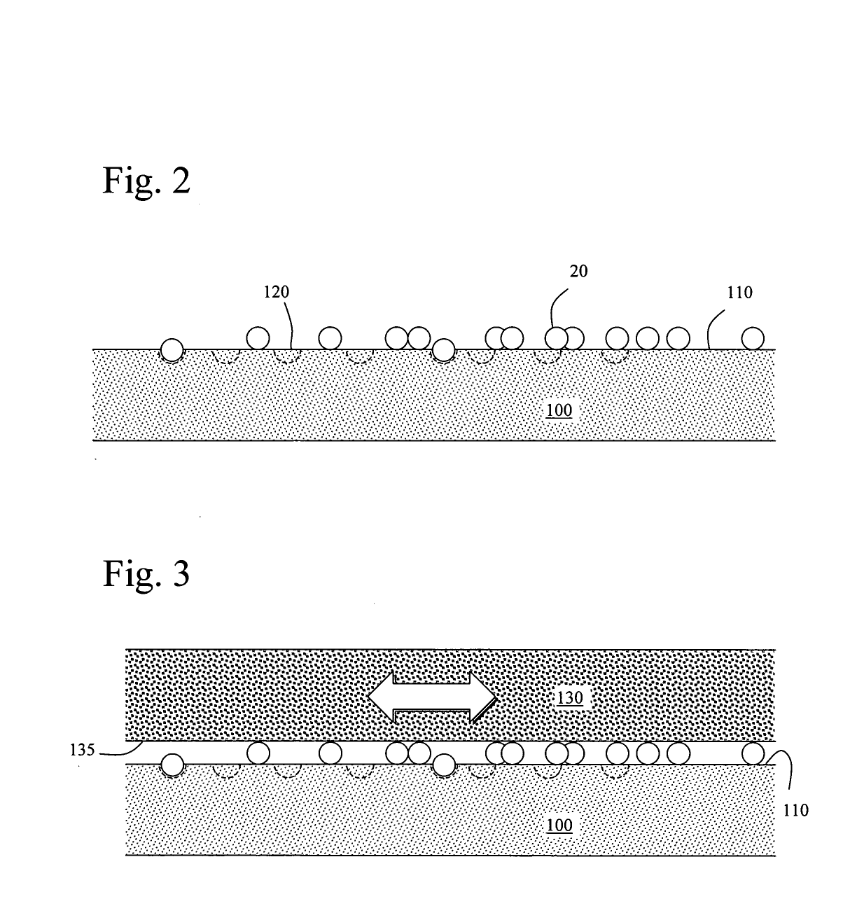

As illustrated in FIG. 2, the diffusion has several advantageous characteristics. The diffused precipitated phase modifies the surface characteristics of elastomer 100 by creating micro-craters 120 on elastomer surface 110.

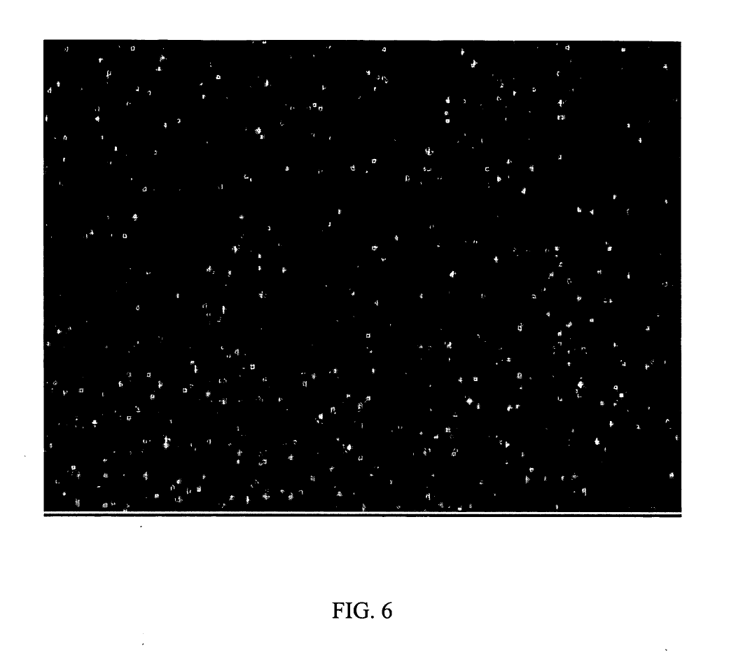

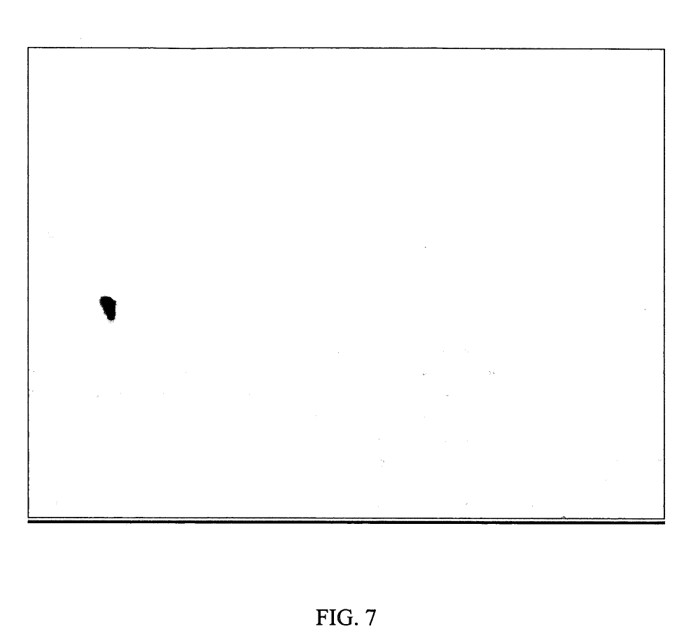

The diffusion has several advantageous characteristics. The diffused precipitated phase modifies the surface characteristics of the elastomers by creating micro-craters on the surface as seen in FIG. 5. The photo shows a 50× magnification of a molded surface, which is shiny to the eye and “grabby” to the touch. FIG. 6 shows a 50× magnification of the surface during the cooling period where the surface is dull to the eye and smooth to the touch.

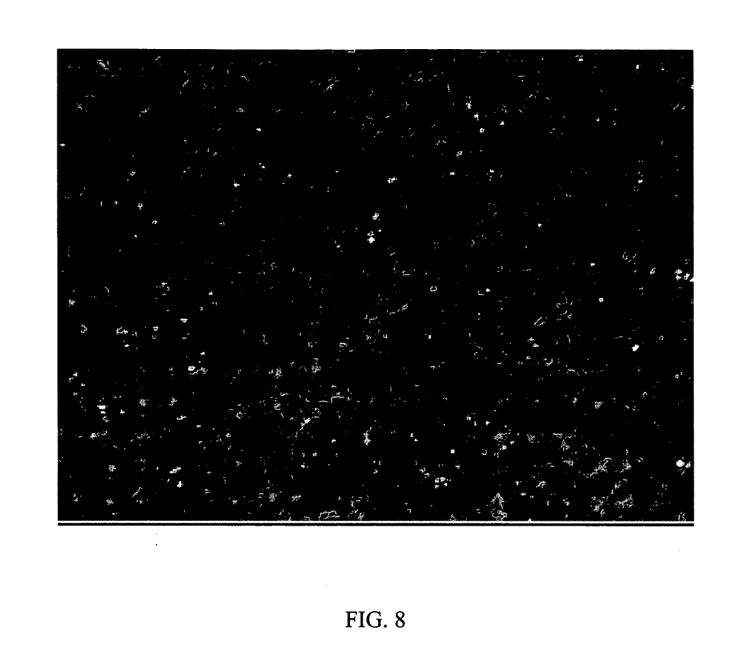

A second advantage to the diffusion is that this process modifies the surface characteristics of the elastomer by providing a dry layer of microscopic powder. As seen in FIG. 7, after an appropriate cooling period, the surface is powdery to the eye and to the touch. As indicated in FIG. 8, after an inappropriate cooling period, the surface is rough to the touch and an excessive amount of powder is visible to the eye.

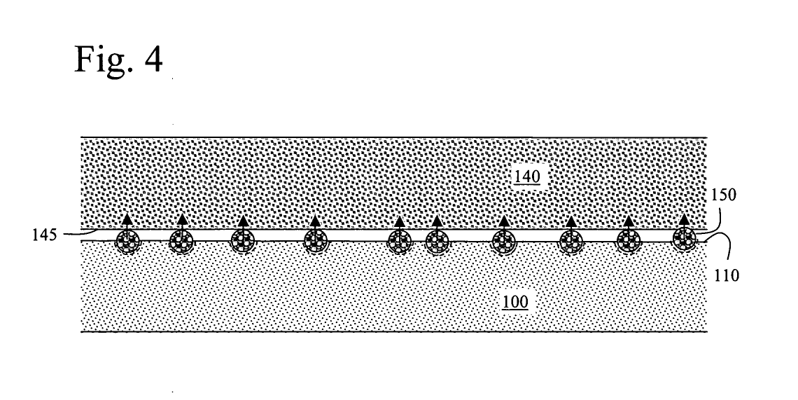

The surface modifications achieved by the novel method reduce the friction between the skin or other human tissue and the elastomer. In FIG. 3, epidermal tissue 130 having skin surface 135 abuts molded surface 110 whereby precipitated additive 20 reduces lateral movement friction. Thus a lubricant may be added to molded surface 110 and retained by micro-craters 120 prior to contact with epidermal tissue 130. This is an advantageous feature in applications such as burn patient treatment applications, scar reduction pads, wound care dressings, goggle frames, masks, headbands, orthotics, prosthetics, garments, urinary catheters, temporary implantations, and applications of cosmetics. Other applications not expressly mentioned herein are also within the scope of this invention as a matter of law.

The surface modifications are beneficial when the surface is wet with water or other liquid fluids. The micro-craters collect small pools of liquid which, in turn, provide additional lubricity. This is advantageous in medical, personal care, and cosmetic care applications, for example.

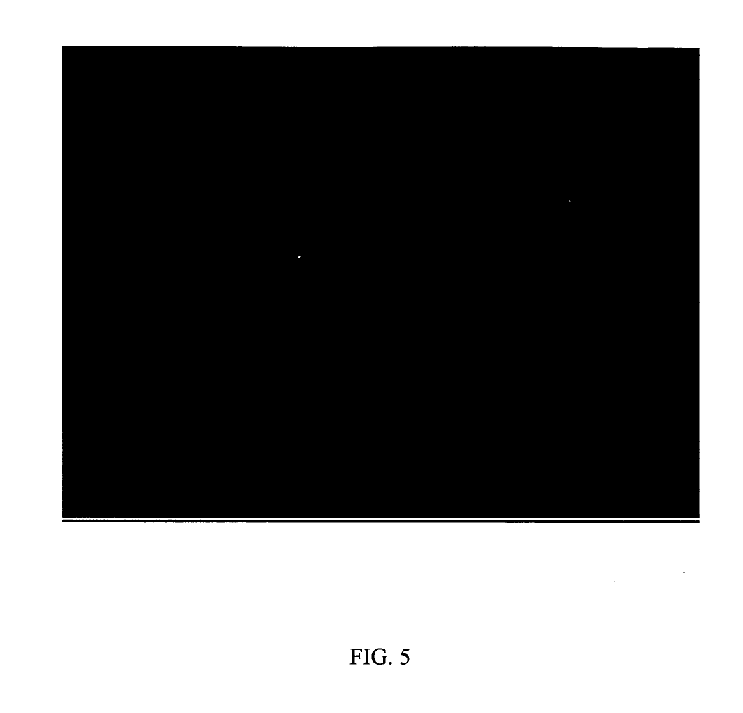

The surface modification techniques disclosed herein may also be harnessed to transport compounds beneficial to the skin or other human tissue to the surface of the elastomer providing therapeutic or cosmetic benefits to such skin or other issue. As shown in FIG. 4, permeable tissue target 140 having tissue surface 145 abuts molded surface 110 wherein therapeutic compound 150 embedded in micro-craters 120 migrates through tissue surface 145 to deliver compound 150 to tissue target 140. Therapeutic compounds may be applied to molded surface 110 and retained by the micro-craters 120 for contact with tissue target 140. Such compounds may include, but are not limited to, vitamins, nutrients, antibiotics, antimicrobials, fungicides and cancer treatments.

It will thus be seen that the objects set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Now that the invention has been described,

1. A method of making an elastomer, comprising the steps of:
mixing together plasticizing oil, polymer, and at least one additive to form a mixture;
melting the mixture so that the additives are dissolved in a stable solution;
forming a preselected item from the mixture;
allowing the preselected item to cool until it solidifies and becomes an elastomer;
whereby the at least one additive precipitates after the solidification of the elastomer; and
whereby the at least one additive migrates to the surface of the elastomer to form a dry powder that covers the surface and provides a lubricant .

2. The method of claim 1, wherein the amount of the at least one additive is proportionally in excess of an amount of additive that is soluble in the elastomer at room temperature.

3. The method of claim 1, wherein the at least one additive is added to the mixture of polymer and plasticizing oil in when the mixture is in its molten state.

4. The method of claim 1, further comprising the step of stretching the elastomer after the elastomer has solidified.

5. The method of claim 1, further comprising the step of mixing a seed oil with an insoluble fine powder to the plasticizing oil.

6. The method of claim 1, further comprising the step of posting a precipitation seed on the molded elastomer.

7. The method of claim 1, further comprising the step of selecting the at least one additive from a group consisting of Tetrakis (2,4-di-tert-butylphenyl) [1,1-biphenyl]-4,4′-diylbisphosphonite; Tris (2,4-ditert-butylphenyl) phosphate; Butanedioic acid, dimethylester, polymer with 4-hydroxy-2,2,6,6-tetramethyl-1-piperidine ethanol; 2,6-di-tert-butyl-4-(4,6-bis(octylthio)-1,3,5-triazin-2-ylamino) phenol; 3,3′,3′,5,5′,5′-hexa-tert-butyl-a,a′,a′-(mesitylene-2,4,6-triyl) tri-p-cresol; and Pentaerythritol Tetrakis (3-(3,5-di-tert-butyl-4-hydroxphenyl)propionate).

8. The method of claim 1, further comprising the step of selecting the polymer from a group consisting of poly (styrene ethylene ethylene propylene styrene), poly (styrene ethylene butylene styrene), and poly (styrene ethylene propylene styrene).

9. A method of making an elastomer, comprising the steps of:
mixing together a mineral oil, a polymer, and a predetermined amount of additive to form a mixture;
the predetermined amount of additive being proportionally in excess of an amount of additive that is soluble in the mixture at room temperature;
increasing the temperature of the mixture to a melting point where the additive becomes soluble in the molten mixture in a stable solution;
allowing the mixture to cool to form an elastomer;
whereby the additive precipitates from the elastomer and migrates to the surface of the elastomer in the form of a dry powder as the elastomer solidifies.

10. The product of the method of claim 9.

11. The product of claim 10, wherein the additive is selected from a group consisting of Tetrakis (2,4-di-tert-butylphenyl) [1,1-biphenyl]-4,4′-diylbisphosphonite; Tris (2,4-ditert-butylphenyl) phosphate; Butanedioic acid, dimethylester, polymer with 4-hydroxy-2,2,6,6-tetramethyl-1-piperidine ethanol; 2,6-di-tert-butyl-4-(4,6-bis(octylthio)-1,3,5-triazin-2-ylamino) phenol; 3,3′,3′,5,5′,5′-hexa-tert-butyl-a,a′,a′-(mesitylene-2,4,6-triyl) tri-p-cresol; and Pentaerythritol Tetrakis (3-(3,5-di-tert-butyl-4-hydroxphenyl)propionate).

12. The product of claim 10, wherein the polymer is selected from a group consisting of poly (styrene ethylene ethylene propylene styrene), poly (styrene ethylene butylenes styrene), and poly (styrene ethylene propylene styrene).

13. A method of making micro-craters on the surface of an elastomer, comprising the steps of:
mixing together plasticizing oil, polymer, and at least one additive to form a mixture;
melting the mixture so that the additives are dissolved in a stable solution;
forming a preselected item from the mixture;
allowing the preselected item to cool until it solidifies and becomes an elastomer whereby the at least one additive precipitates after the solidification of the elastomer and the at least one additive migrates to the surface of the elastomer to form a dry powder that covers the surface; and
removing the dry power from the surface whereby micro-craters are left on the surface of the elastomer.

14. The method of claim 13 further comprising the step of applying a therapeutic compound to the surface of the elastomer prior to contact with a tissue target.

15. The method of claim 14 wherein the therapeutic compound is selected from the group consisting of vitamins, nutrients, antibiotics, antimicrobials, fungicides and cancer treatments.

16. The method of claim 13 further comprising the step of applying a lubricant to the surface of the elastomer prior to contact with epidermal tissue.

17. The method of claim 16 wherein the preselected item is selected from the group consisting of bum patient treatment applications, scar reduction pads, wound care dressings, goggle frames, masks, headbands, orthotics, prosthetics, garments, urinary catheters, temporary implantations, and applications of cosmetics.
